(19) United States
(12) Patent Application Publication
(10) Pub. No.: US 2008/0147488 A1
(43) Pub. Date: Jun. 19, 2008

(54) System and method for monitoring viewer attention with respect to a display and determining associated charges

(76) Inventors: James A. Tunick, New York, NY (US); Tony L. Rizzaro, Harrison, NY (US); Evan Barba, Suffern, NY (US); Kuan Huang, Astoria, NY (US)

Correspondence Address: BRANDON N. SKLAR. ESQ. (PATENT PROSECUTION);KAYE SCHOLER, LLP, 425 PARK AVENUE, NEW YORK, NY, 10022-3598, US

(21) Appl. No.: 11/975,834

(22) Filed: Oct. 22, 2007

Related U.S. Application Data
(60) Provisional application No. 60/853,394, filed on Oct. 20, 2006.

(51) Int. Cl. G06Q 30/00; G06Q 10/00; G06Q 99/00; G06K 9/62

(52) U.S. Cl. 705/10; 705/400; 705/34; 705/14; 382/209

(57) ABSTRACT

In an example of an embodiment of the invention, data relating to at least one impression of at least one person with respect to a display is detected, and a party associated with the display is charged an amount based at least in part on the data. The at least one impression may include an action of the person with respect to the display. The action may comprise a gaze, for example, and the method may comprise detecting the gaze of the person directed toward the display. The person's gaze may be detected by a sensor, for example, which may comprise a video camera. An invoice may be generated based at least in part on the data, and sent to a selected party. The display may comprise one or more advertisements, for example. A face monitoring update method is also disclosed. Systems are also disclosed.

### RELATED APPLICATION

The present application claims the benefit of U.S. Provisional Patent Application No. 60/853,394, which was filed on Oct. 20, 2006, is assigned to the assignee of the present invention, and is incorporated by reference herein in its entirety.

### FIELD OF THE INVENTION

The present invention is directed to systems and methods for collecting information concerning viewer attention with respect to displays. More specifically, the present invention is directed to collecting information concerning viewing by individuals of advertisements and determining charges to be billed to advertisers based, at least in part, on the information collected.

### BACKGROUND OF THE INVENTION

Marketers and retailers in America annually spend over eight billion dollars on point-of-purchase (“POP”) advertising, and the growth of this category of marketing expenditure over the last few years has been steady. There has also been growth in “in-store services,” in part, as a result of new retail categories (drug stores and mass merchandisers, for example) joining what was traditionally a supermarket business. For example, in-store TV networks in retailers, such as Wal-Mart, Sears, and Best Buy have recently delivered large audiences. Some retailers have recently announced plans to improve the performance of in-store TV advertising by running different ads in different departments rather than the same ads storewide. Brand recall studies by Nielsen have showed that these TV monitors delivered improved brand recall compared to the industry average for in-home TV advertising.

To prove successful marketing strategies and tactics, marketers need to assimilate large amounts of data in order to recognize trends and change content accordingly. A variety of marketing tools and metrics allow marketers to track the success of their marketing message and consequently their return-on-investment (“ROI”). Some metrics, such as monthly sales figures, give marketers an indication of the success of their total marketing/sales efforts. Sales figures however, do not pinpoint which areas of investment are making their proper proportionate contribution to the brand/company's goals. In the realm of web-based advertising, metrics such as click tracking use electronic media to track user interest in certain ads, allowing website owners to sell ad space based on the “pay-per-click” business model. Software programs record exactly which ads people click on, gathering information about viewer preferences. Once given the data, advertisers can choose to continue or modify their advertisements.

Marketers may use digital displays for advertising on buildings and billboards as well as in malls, building lobbies, subways, stores, clubs, and elsewhere. This is a way for them to deliver messages to a very specific captive audience. Commonly used metrics for monitoring the effectiveness of signage networks and other out-of-home advertising include, for example, the Cost-Per-Thousand method (also referred to as “CPM”), which attempts to determine a cost associated with one thousand “views,” and the advertiser is charged based on the estimated amount. This method is based on a “best guess” as to how many people will view the advertisement, and is therefore widely known to be inaccurate. The CPM method is incapable of obtaining information about actual viewing activity, and therefore also cannot obtain additional information, such as information concerning the demographics of viewers.

### Basics of Pattern Classification

In the field of machine learning there exist a number of mathematical techniques which, when applied on a dataset of images, can yield object or feature detection and recognition in varying time-frames and with different degrees of reliability.

A linear classifier is the simplest technique for feature detection, or classification. It is a computed mathematical model of a decision (yes/no in the simplest case, although more complex decisions are common) created using techniques of linear algebra and statistical analysis. The most basic formula for computing a linear classifier is:

$$y = f ( \vec{w} \cdot \vec{x} ) = f ( {\sum }_{j} {w}_{j} {x}_{j} ) ,$$

(source: Wikipedia, “Linear Classifier”)
   where f is a linear discriminant function that converts the dot-product of the real vectors w and x into the correct output y. The vector w in this case is a vector of “weights” which can be “learned” by the classifier through an update procedure, and the vector x is a vector of features for which classification is required. There is also often the addition of a “bias” which is typically represented by w₀ that can also be learned, so that y=w₀ when the dot-product itself is equal to 0. The weights determine how the features are divided into the yes/no categories in a “linearly separable” space (a space which can be divided into regions representing yes and no).

If it is presumed that all the possible differences in a dataset (an image in this case) can be represented by a number of N-dimensional x vectors then it is possible to create a “decision-surface” or N-1 dimensional hyperplane that divides the N-dimensional space into the yes/no categories. Linear classifiers learn this decision-making ability through a “training” procedure in which a number of correct and incorrect examples are introduced and labeled accordingly. A mathematical mean regression (linear in this example, although logarithmic is also used) or some other learning procedure is applied to the variable in question, typically the weights and bias, until a reasonable amount of error is obtained.

After this training procedure, the classifier can then be presented with any number of test cases, which are feature vectors of the same type as the dataset. Upon the introduction of new examples the classifier will determine the probabilities that the sample is like the correct and incorrect examples it is trained on. If it determines that the test vector has a higher probability of belonging to the “yes” side or to the “no” side of the decision surface (the test vector lies closer to one or the other) it will return the appropriate answer.

### The OpenCV Classification Scheme

One classification scheme is available from the Open Source Computer Vision Library (“OpenCV”). Open CV is an open-source library of programming functions aimed at developing real-time computer vision, and includes applications relating to object identification, face recognition, etc. OpenCV is available at www.intel.com/technology/computing/opencv, for example. The classifier implemented in OpenCV trains a “cascade” or tree of boosted classifiers (boosted according to a known learning procedure) on a dataset that consists of “haar-like features.” These features look like rectangles of various sizes and shapes with contrasting sub-rectangles of light and dark regions. These contrasting regions are very much like square “wavelets” of image intensity which were first discovered by Alfred Haar, thus the name, Haar-wavelet.

They have the equation:

$$f ( x ) = \{ \begin{matrix}1 & 0 \geq x < 1 / 2 , \\ - 1 & 1 / 2 \leq x < 1 , \\ 1 & otherwise .\end{matrix}$$

### FIG. 1A shows an example of a Haar wavelet.

The features used by OpenCV include edge features, line features, and center-surround features, as illustrated in FIG. 1B. The graph shown in FIG. 1B could represent a finite pattern of alternating light/dark image intensities, or features, which the classification scheme attempts to identify. The graph of FIG. 1B is drawn from the OpenCV documentation available at the OpenCV website discussed above. In particular, the graph is included in the Pattern Recognition section of the CV Reference Manual.

The “cascading” or tree-like structure of the implemented classification scheme means that the overall classification is done hierarchically, in steps or stages, with regions of interest in the image that are classified as fitting one or more of the above features being passed up the tree (or down the cascade) for further classification. Once all stages are passed the classifier can be said to have decided that the region of interest is in fact one of the features it has been trained to identify.

One important application of linear classifiers that is known in the art is face recognition. One challenge in using a classification scheme such as the OpenCV scheme described above is that the features used (which are shown in FIG. 1B) are not faces, and are not inherently associated with faces. In order to determine whether a region of interest in a given image is a face or not, these features must be grouped together in a meaningful way. The classification implementation scans the image a number of times at varying scales and uses user defined parameters to determine what may be called the “face-ness” of the region of interest. These parameters include such things as the number of adjacent features to look for, and selected heuristics to simplify the search, such as edge-detection, and the starting scale of possible regions of interest. The algorithm also looks for overlap in regions of interest so that features at different locations in the image can still be detected.

### SUMMARY OF THE INVENTION

Current methods used to monitor viewer attention with respect to out-of-home, or publicly displayed, advertising such as billboards, building signage, mall flatscreens, or printed posters or even end-aisle displays remain relatively unsophisticated. Improved systems and methods enabling advertisers to obtain and analyze information concerning the effectiveness of actual viewing of out-of-home advertisements would be advantageous. It would also be advantageous to provide methods and systems to use information concerning the viewing of out-of-home advertisements effectively, for example, as a basis to charge advertisers and/or other parties, to capitalize on such information to improve sales, to enhance advertising campaigns, etc.

In an example of an embodiment of the invention, a method to charge a party for a display is provided. Data relating to at least one impression of at least one person with respect to a display is detected, and a party associated with the display is charged an amount based at least in part on the data. The at least one impression may include an action of the person with respect to the display. The action may comprise a gaze, for example, and the method may comprise detecting the gaze of the person directed toward the display. The person's gaze may be detected by a sensor, for example, which may comprise a video camera. An invoice may be generated based at least in part on the data, and sent to a selected party. The display may comprise one or more advertisements.

Detecting the data may comprise generating an image and deriving information from the image. In one example, at least one video image is examined, and the impression is identified based at least in part on information in the video frame. Data relating to at least one impression of a plurality of persons during a predetermined time period may be detected.

In another example, second data is derived based at least in part on the data. The second data may comprise one or more items of information relating to the at least one person, chosen from the group consisting of: a number of impressions that occur during a selected time period, a duration of at least one impression, an average duration of impressions occurring during a selected time period, a number of concurrent impressions, a total number of gazes toward the display, an amount of time associated with one or more gazes, a number of concurrent gazes by the at least one person, a part of the display viewed by the at least one person, age information, race information, ethnicity information, gender information, average age information, one or more facial expressions of the at least one person, one or more emotions of the at least one person, information relating to a voice of the at least one person, one or more gestures of the at least one person, whether the at least one person has appeared multiple times before a selected display, mobile device use, whether and how often the at least one person has made any phone calls, whether and how often the at least one person has used Bluetooth, whether and how often the at least one person has used text messaging, information obtained from a cell phone, information obtained from a Radio Frequency Identification Technology device, crowd flow analysis information, one or more colors worn by the at least one person, and time data.

In another example of an embodiment of the invention, a system to charge a party for a display provided. The system comprises at least one device configured to detect data relating to at least one impression of at least one person with respect to a display. The system further comprises at least one processor configured to charge a party associated with the display an amount based at least in part on the data. The at least one device may comprise at least one video camera configured to generate at least one video image, and at least one second processor configured to examine the at least one video image and identify the impression based at least in part on information in the video frame.

In another example of an embodiment of the invention, a method to charge a party for a display is provided. Data relating to at least one impression of at least one person with respect to a display is obtained, and a party associated with the display is charged an amount based at least in part on the data. The data relating to at least one impression of at least one person with respect to a display may be received by a first party from a second party different from the first party.

In another example of an embodiment of the invention, a method to acquire information concerning actions by individuals with respect to a display is provided. An image comprising a representation of at least one first person proximate to a display is examined, and a first face of the first person is identified. The first face is compared to one or more second faces of one or more respective second persons, which are represented by data stored in at least one memory. The memory may comprise one or more databases, for example. If the first face matches a second face, second data representing the matching second face is updated based at least in part on the first face. If the first face does not match any second face stored in the database, third data representing the first face is stored in the at least one memory. A report is generated based at least in part on information relating to the first and second faces stored in the at least one memory, and the report is provided to a selected party. The display may comprise an advertisement, for example.

In one example, the image comprising the representation of the at least one first person is generated by a sensor. Fourth data representing the first face may be stored in a selected database in the at least one memory, and the fourth data may be removed from the selected database, if the first face matches a second face. In this way the fourth data representing the first face is updated.

The data representing the second faces may comprise one or more data items chosen from the group consisting of: a center of a selected second face, a unique identifier of the selected second face, an indicator of a time in which the selected second face first appeared, an indicator of a video frame in which the selected second face first appeared, a number of video frames in which the selected second face has appeared, a number of video frames in which the selected second face has not appeared since the selected second face first appeared, coordinates associated with a rectangle containing the selected second face, an indicator indicating whether or not the selected second face has appeared in a previous video frame, and an indicator indicating whether or not the selected second face is considered a person.

A second face represented by specified data in the at least one memory may be selected, and a first value indicating a first number of images in which the selected second face has appeared and a second value indicating a second number of images in which the selected second face has not appeared are examined. If the first value exceeds a first predetermined threshold and the second value exceeds a second predetermined threshold, the specified data representing the selected second face is removed from the at least one memory.

A processor may identify the first face and compare the first face to one or more second faces of one or more respective second persons, the second faces being represented by data stored in the at least one memory.

In another example of an embodiment of the invention, a system to acquire information concerning actions by individuals with respect to a display is provided. The system comprises a memory configured to store data. The system further comprises at least one processor configured to examine an image comprising a representation of at least one first person, identify a first face of the first person, and compare the first face to one or more second faces of one or more respective second persons, the second faces being represented by data stored in the at least one memory. If the first face matches a second face, the processor updates second data representing the matching second face based at least in part on the first face. If the first face does not match any second face stored in the at least one memory, the processor stores third data representing the first face in the at least one memory. The processor is also configured to generate a report based at least in part on information relating to the first and second faces stored in the at least one memory, and provide the report to a party in response to a request for desired information relating to first person and second persons.

In another example of an embodiment of the invention, a computer readable medium encoded with computer readable program code is provided. The program code comprises instructions operable to examine an image comprising a representation of at least one first person and identify a first face of the first person. The program code further comprises instructions operable compare the first face to one or more second faces of one or more respective second persons, the second faces being represented by data stored in at least one memory. In accordance with the instructions, if the first face matches a second face, second data representing the matching second face is updated based at least in part on the first face. If the first face does not match any second face stored in the at least one memory, third data representing the first face is stored in the at least one memory. The program code may also comprise instructions operable to generate a report based at least in part on information relating to the first and second faces stored in the at least one memory, and provide the report to a party in response to a request for desired information relating to first person and second persons.

### BRIEF DESCRIPTION OF THE DRAWINGS

Example embodiments of the present invention are described herein with reference to the following drawings, in which:

FIG. 1A shows an example of Haar wavelets;

FIG. 1B shows several features used by the Open Source Computer Vision Library (“OpenCV”);

FIG. 2A is an example of a communication system 100, in accordance with an embodiment of the invention;

FIG. 2B is a block diagram of an example of a sensor/processing system, in accordance with the embodiment of FIG. 1;

FIG. 3A is a block diagram of an example of the media player client terminal 221, in accordance with the embodiment of FIGS. 1 and 2;

FIG. 3B is a block diagram of an example of the monitoring client terminal 110, in accordance with the embodiment of FIG. 1;

FIGS. 4A and 4B show an example of a method for monitoring impressions across one or more displays and billing clients based at least in part on the number of impressions, in accordance with an embodiment of the invention;

FIG. 4C is an example of an invoice that may be generated based on impression data, in accordance with an embodiment of the present invention; and

FIGS. 5A and 5B are flowcharts of an example of a method for identifying and monitoring impressions in video images, in accordance with an embodiment of the invention.

### DETAILED DESCRIPTION

While the present invention is described herein with reference to illustrative embodiments for particular applications, it should be understood that the present invention is not limited these embodiments or applications. Other systems, methods, and advantages of the present embodiments will be or become apparent upon examination of the following drawings and description. It is intended that all such additional systems, methods, features, and advantages be within the scope of the present invention.

In an example of one embodiment of the invention, a method to monitor a viewer's attention with respect to a display, such as an advertisement, and to charge a party, such as an advertiser, an amount based on the viewer's activity, is provided. Thus, in one example, at least one impression by a person with respect to a display is detected, where the at least one impression includes at least one instance when the person's gaze is directed toward the display. Information concerning the at least one impression is recorded, and a party associated with the display is charged an amount determined based at least in part on the recorded information. In other examples, an impression may include one or more viewer actions, such as talking, smiling, laughing, gestures, interaction with the display, etc.

The present embodiments may be operated in software, in hardware, or in a combination thereof. However, for sake of illustration, the preferred embodiments are described in a software-based embodiment, which is executed on a processing device, such as a computer. As such, the preferred embodiments take the form of a software program product that is stored on a machine readable storage medium and is executed by a suitable instruction system in the processing device. Any suitable machine readable medium may be used, including hard disks, CD-ROMs, optical storage devices, or magnetic storage devices, for example.

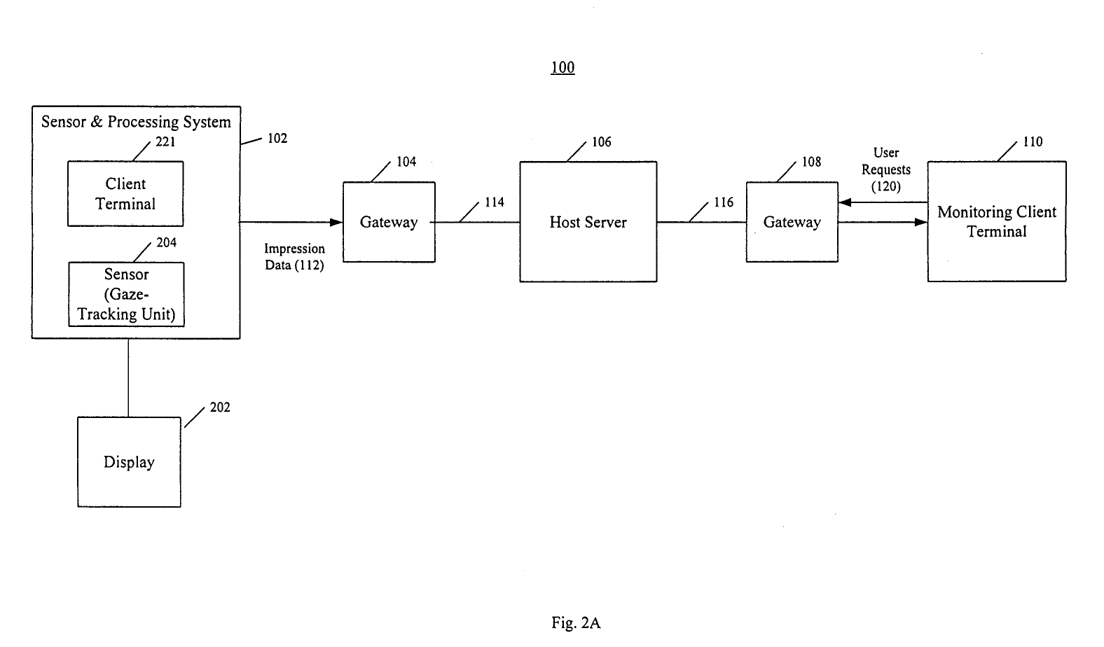

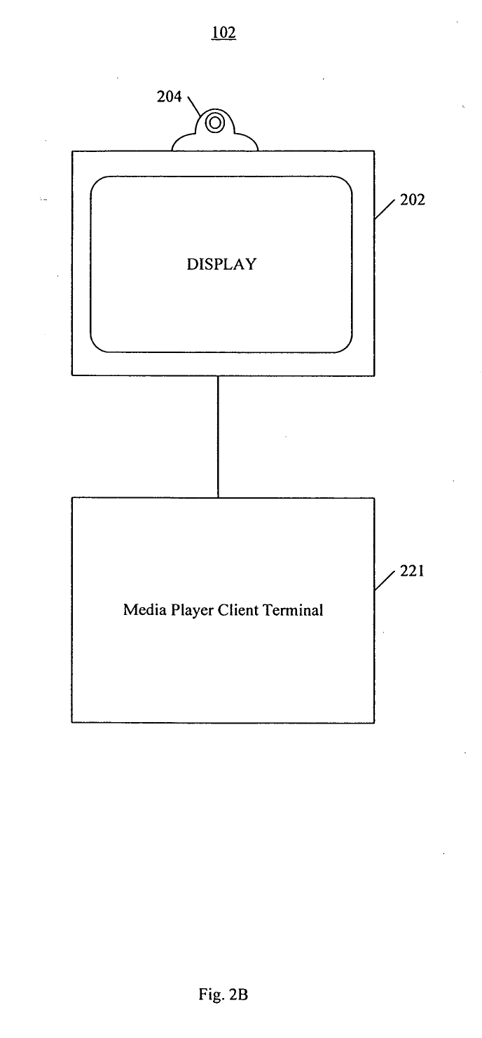

FIG. 2A is an example of a communication system 100, in accordance with an embodiment of the invention. The communication system 100 comprises a host server 106, a sensor/processing system 102, a monitoring client terminal 110, and gateways 104 and 108.

In this example, the sensor/processing system 102 is connected to a display 202 that may show one or more advertisements, for example. The display 202 may comprise an electronic display such as a CRT-based video display, a video projection, an LCD-based display, a gas plasma-panel display, a display that show three-dimensional images, a volumetric display, or a combination thereof. In other examples, the sensor/processing system 102 is not connected to, but is located in physical proximity to, or in visual proximity to, the display 202. In other examples, the display 202 may comprise a non-electronic display such as a billboard, a sign, a painting, a work of art, or any other visual presentation. For example, the sensor 204 may be positioned above a painting in the museum, and/or used in a museum to monitor interest in particular works of art or exhibits. Alternatively, the sensor 204 may be used in to monitor interest in one or more signs in a sports stadium.

The sensor/processing system 102 comprises a sensor 204 capable of gathering information concerning the actions of persons viewing the display 202. The sensor 204 may be positioned above, below, at the side of, or otherwise physically positioned with respect to the display 202 such that the sensor 204 may observe and gather information concerning the actions of persons viewing or passing by the display 202. The sensor/processing system 102 also comprises a client terminal 221 that receives data from the sensor 204 and processes the sensor data, generating additional information.

In one example, the sensor 204 may comprise a gaze tracking unit capable of detecting and monitoring when a viewer's attention or gaze is directed at the display 202, for example. In this discussion, the sensor 204 is sometimes referred to as a gaze tracking unit 204.

The sensor/processing system 102 generates impression data 112 relating to viewer activity, and transmits the impression data to the host server 106. The impression data 112 includes data generated by the sensor 204 and/or data generated by the client terminal 221.

As mentioned above, in one example, the sensor 204 comprises a gaze-tracking unit capable of detecting the direction of a viewer's gaze, preferably in a non-intrusive manner. The gaze-tracking unit 204 may comprise one or more (analog or digital) video cameras, for example. If the gaze tracking unit 204 detects the viewer's eyes shifting toward a selected advertisement shown on the display 202, the gaze tracking unit 204 generates a signal, which may be transmitted to a report generating application of the occurrence of such an event. Such an event may be recorded as a single “impression” and recorded in a database, or stored in another manner. As used herein, the term “impression” refers to a set of data obtained with respect to one or more persons who are perceived by the sensor (gaze tracking unit) 204. For example, an impression may include data detected by the sensor 204, indicating that a particular person looked at the display, that the person looked away from the display, etc. Information from one or more impressions may be analyzed to generate additional information, such as information indicating how long a person looked at the display, or the age, gender, or race of a viewer. Accordingly, impression data may include both data detected by the sensor 204, and additional information generated by analyzing the sensor data. These and other types of impression data that may be detected, generated and recorded are described in more detail below. In other examples, the gaze-tracking unit 204 may comprise a digital camera or a still camera. While in this example, the sensor 204 comprises a camera for obtaining image information, in other examples the sensor 204 may comprise other types of sensors for detecting other types of information. For example, the sensor 204 may comprise a microphone, an infrared sensor, an ultrasonic sensor, a flex-sensing resistor, a touch-sensitive material such as touch screens, a pressure-sensing device, an electromagnetic sensor, or other types of sensing technologies.

There are many currently existing technologies providing gaze detection and tracking functionality. Any available gaze-tracking technology may be used. For example, in one embodiment, the gaze tracking unit 204 comprises a video-based gaze-tracking unit, such as a USB webcam available from Logitech Group, located in Fremont, Calif., for example. The sensor/processing system 102 further comprises a Thinkpad X40, available from Lenovo Inc., of Morrisville, N.C., for example. The Thinkpad X40 in this example runs Microsoft Windows XP Professional, available from Microsoft Corporation, of Redmond, Wash.

As mentioned above, the gaze tracking unit 204 and/or the client terminal 221 detect, determine and monitor data relating to impressions, such as the duration of an impression, the average duration of impressions, the number of concurrent impressions, etc. The gaze tracking unit 204 and/or the client terminal 221 may also detect, determine and monitor the total number of gazes toward the display 202, the amount of time for each gaze, and the numbers of concurrent gazes by groups, the specific part of the display people look at, etc. In this example, the gaze tracking unit 204 and/or the client terminal 221 monitor viewers attention directed toward one or more selected out-of-home advertisements (such as billboards, video displays in a mall, street signage, etc.).

The gaze tracking unit 204 and/or the client terminal 221 may also be capable of detecting, determining and/or monitoring other data relating to an impression. In some instances the client terminal 221 analyzes images detected by the gaze tracking unit 204 and obtains or determines additional information relating to a viewer or the viewer's actions. Thus, impression data may comprise various types of information relating to an advertisement and the viewers thereof. For example, impression data may comprise demographic data—a viewer's age, race or ethnicity, and/or gender, and/or information concerning the average age of all viewers, and information showing the distribution of viewers by race, ethnicity or gender. Impression data may also comprise information relating to a viewer's facial expressions and/or emotions, information relating to a viewer's voice (including an analysis of words spoken by the viewer), and/or information concerning a viewer's gestures, including how the viewer moves and interacts with the display. Impression data may further include information indicating repeat viewer tracking (if the same person or people have appeared multiple times before a single display or before different, selected displays in a store). Impression data may additionally include information about a viewer's use of cellphones or other mobile devices. For example, the impression data may include data indicating whether and how often a viewer made any phone calls, used Bluetooth, used text messaging, etc.

Impression data may also comprise information related to passersby in addition to or instead of the viewers themselves. Impression data may be obtained from devices such as cell phones or RFID (Radio Frequency Identification Technology) devices, for example. Impression data may also comprise information indicating the presence or passage of people, which may be used in crowd flow analysis to provide analytics about audience movement and traffic patterns throughout a store. Such information may indicate “hot spots” of high interest in a store, for example, the direction of a person, the average direction of people in a store, etc. The impression data may also track colors—the colors of a person's clothing and accessories, or the popularity of different colors. Impression data may also include information indicating the time of day, day of the week or month, etc., relevant to an impression or any particular data item. The impression data 112 may contain all or some of this information. Other information may be acquired, as well.

The impression data 112 is transmitted from the sensor/processing system 102 over a communication link 114 to the host server 106. The host server 106 processes the impression data 112 generated by the sensor/processing system 102, and transmits information, which may comprise a report based on the impression data, for example, over communication link 116 to the monitoring client terminal 110. Gateways 104 and 108 are used to facilitate communications between the client terminals 102 and 110, and the host server 106. Each of the communication links 114 and 116 may comprise a direct connection, or may comprise a network or a portion of a network. For example, each communication link 114 and 116 may comprise, for example, an intranet, a local area network (LAN), a wide area network (WAN), an internet, Fibre Channel storage area network (SAN) or Ethernet. Alternatively, network 150 may be implemented as a combination of different types of networks. The gateways 104 and 108 may comprise, without limitation, one or more routers, one or more modems, one or more switches, and/or any other suitable networking equipment.

While a single host server 106 is shown in FIG. 2A, the sensor/processing system 102 may establish connections to more than one host server. Also multiple host servers and multiple monitoring clients could establish connections to more than one sensor/processing system. The sensor/processing system 102 need not be a computer. For example, a small microprocessor, or an individual sensor capable of recording the metrics data, may be used. For example, the sensor/processing system 102 may comprise a video camera with a microcontroller.

An operator of the monitoring client terminal 110, who may be an administrator, for example, may view the impression data provided from the sensor/processing system 102 and the information provided by the host server 106, using software running on both the host server 106 and the monitoring client terminal 110. Such information may be viewed at a display device associated with the monitoring client terminal 110, and may be presented in the form of a report, an invoice, or other format. The operator may cause a report to be generated on the monitoring client terminal 110, for example. Reports may be generated automatically (without the intervention of an operator or administrator), manually (with the intervention of an operator or administrator), or automatically in part and manually in part. An operator/administrator may alternatively view the impression data, reports, invoices, etc., and other information using a display device associated with the host server 106.

Upon viewing the report conveying the impression data, or a portion thereof, an operator/administrator may take one or more actions, such as charging a party based on information in the impression data. An invoice may be generated, for example, based on the number of impressions detected with respect to a particular client's advertisement. The invoice may then be sent to the client. Invoices may be generated automatically, manually, or automatically in part and manually in part. For example, upon receiving one or more commands or signals from the administrator, the client terminal 110 or the host server 106 may generate an invoice that reflects the actions taken and the impression data (generally shown on the monitoring client terminal 110). The invoice may also be converted by the client terminal 110 or the host server 106 into email and other formats. Different types of action messages 120, including requests or order types relating to the impression data, may be submitted to the host server 106. Once generated, user action messages 120 may be sent from the monitoring client terminal 110 to the host server 106 over communication links 116. Reports may also be delivered by the monitoring client terminal 110 and/or the host server 106 to a selected device such as a laptop computer, a cellphone, a Blackberry device, a personal digital assistant, a facsimile machine, etc. Reports may also be sent in other forms, for example, a printed report may be sent by mail. Similarly, invoices may be delivered in any suitable format. For example, invoices may be sent in printed form by regular mail, in electronic form by email, by facsimile, etc.

FIG. 2B is a block diagram of an example of the sensor/processing system 102, used in FIG. 2A. In this example, the sensor/processing system 102 comprises a gaze tracking unit 204 for following and tracking positions and movements of the viewer's head and eyes. The sensor/processing system 102 also comprises a processor, such as a client terminal 221, which receives and processes data from the gaze tracking unit 204. In this example the client terminal 221 comprises a media player client terminal.

The gaze tracking unit 204 may detect a viewer's gaze, and then provide data relating to the viewer's gaze position and coordinates, as well as data indicating when the viewer started and stopped looking toward the display, to the media player client terminal 221. While a single gaze tracking unit 204 is shown in FIG. 2B, the sensor/processing system 102 may include multiple gaze tracking units to monitor a viewer's gaze, or the gazes of multiple viewers, in relation to a plurality of displays. Any number of displays or gaze tracking units may be used. In addition, different types of gaze detection may be used besides video tracking. Other types of gaze detection may include, but are not limited to, infrared, ultrasonic, or any other sensing technology.

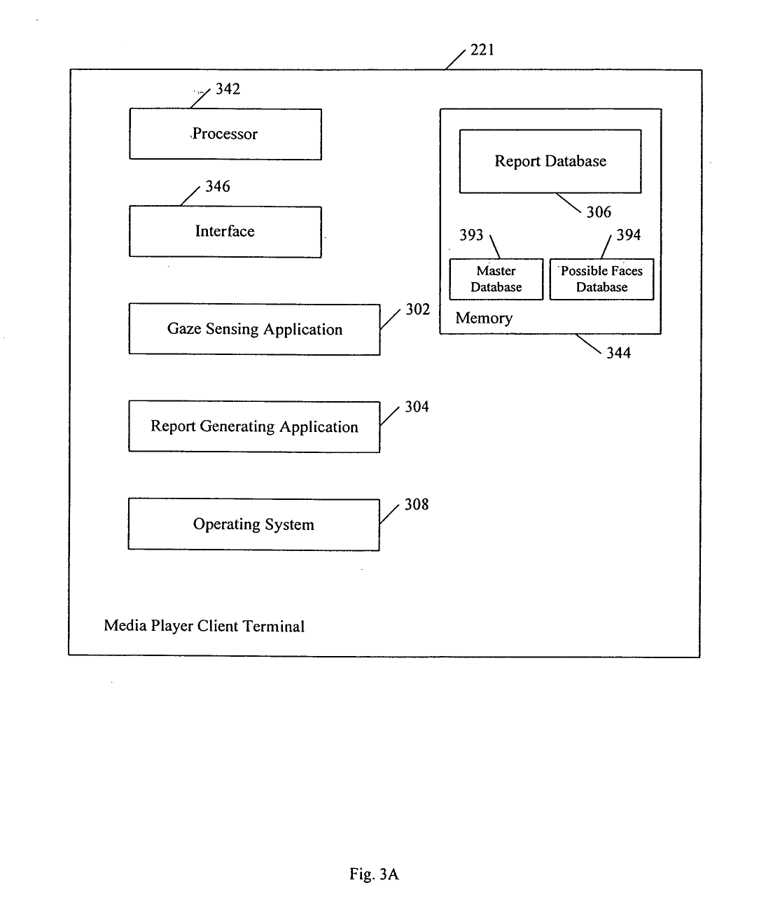

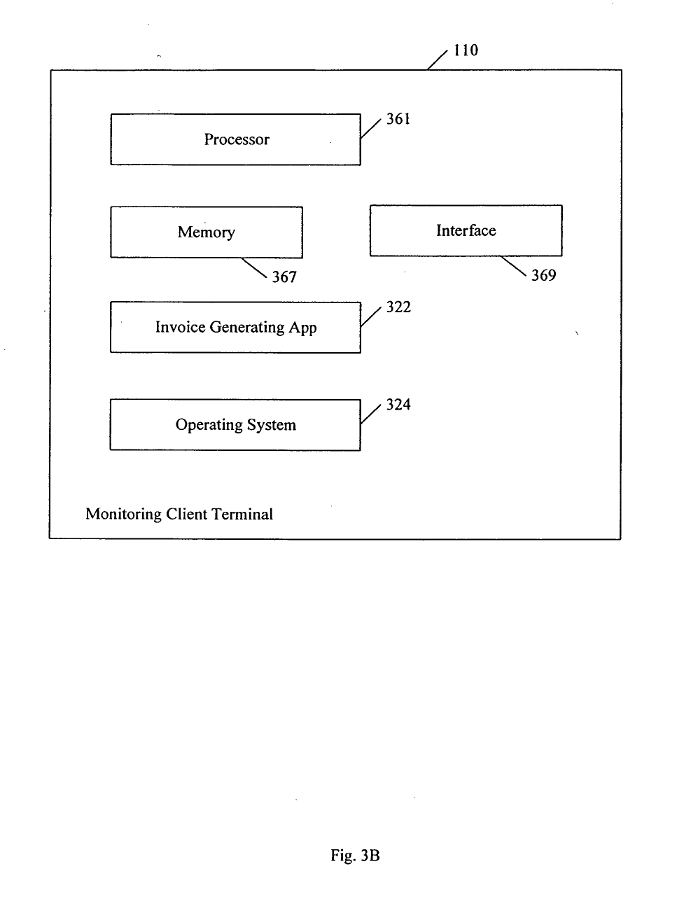

FIG. 3A is a block diagram of an example of the media player client terminal 221, used in FIGS. 2A and 2B. The media player client terminal 221 comprises a processor 342, an interface 346, a memory 344, a gaze sensing application 302, a report generating application 304, and an operating system 308. The processor 342 needs enough processing power to handle and process the expected quantity and types of gaze information over a desired period of time. A typical processor has enough processing power to handle and process various types of impression data. The interface 346 may comprise an application programming interface (“API”), for example. The memory 344 may include any computer readable medium, such as one or more disk drives, tape drives, optical disks, etc. The term computer readable medium, as used herein, refers to any medium that stores information and/or instructions provided to the processor 342 for execution.

An example of a commercially available media player client that allows an administrator to schedule digital content on displays is Webpavement, a division of Netkey, Inc., located in East Haven, Conn. Webpavement also provides an electronic content scheduling interface, referred to as Sign Admin, in which the number of advertising monitors are displayed in association with which content is being shown. Portions of the Webpavement Sign Server and Sign Admin are described in U.S. Patent Publication No. US2002/0055880, filed on Mar. 26, 2001, the contents of which are incorporated herein by reference. Any product that performs translation, storage, and display reporting based on viewer gaze, may be used.

The gaze sensing application 302 receives information concerning a viewer's gaze (or the viewing activity of multiple viewers) from the gaze tracking unit 204. In response, the gaze sensing application 302 generates data relating to one or more impressions. For example, the gaze sensing application 302 may determine the number of viewer's gazes in relation to one or more displays, including digital displays, print ads, or any other visual medium. The gaze sensing application 302 may comprise software controlled by the processor 342 (or by another processor), for example. The gaze sensing application 302 may comprise a classifier such as the classifier available from the OpenCV Library, discussed above. Alternatively, the gaze tracking application 302 may comprise circuitry, or a combination of software and circuitry.

Upon receiving the viewer's gaze position data, the gaze sensing application 302 may first determine the viewer's gaze position coordinates in relation to the display 202. When the gaze sensing application 302 detects a viewer shifting his eyes toward the display 202 (or a portion of a display 202, depending on the client's or administrator's preferences), the gaze sensing application 302 provides a signal to the report generating application 304 directing the report generating application 304 to start recording impression data, including “events” that occur while the viewer is looking at the display. The gaze sensing application 302 continues to monitor the viewer's gaze and detects events relating to the viewer's gaze. Such events may include, without limitation, when the viewer's gaze shifts from one portion of the display to another portion, when the viewer's gaze leaves the display, how long the viewer looks at the display, and other types of impression data, as discussed above. As the gaze sensing application 302 monitors the viewer's gaze and detects events relating to the viewer's gaze, the gaze sensing application 302 transmits corresponding signals to the report generating application.

The report generating application 304 may start storing impression data or any other data while the user is looking at the display. In one example, an impression associated with a particular person continues until the person stops looking at the display. When the person stops looking at the display, the impression is deemed completed, and the impression data associated with that particular impression is stored in one or more records. Among the other impression data, the record may indicate a time when the impression started and a time when the impression ended. Records storing impression data may be stored in the memory 344, for example. In other examples, impression data may be grouped into time periods. For example, impression data collected over a predetermined time period, such as one hour, one day, one week, one month, etc., may be stored in a single record.

At a suitable time after impression data relating to a particular viewer is generated and stored, the report generating application 304 generates a report based, at least in part, on the impression data. For example, the report generating application 304 may begin generating a report based on the impression data associated with a particular viewer after the gaze sensing application 302 determines that the viewer's eyes have turned away from the display 202. The report generating application 304 may alternatively begin generating the report as soon as the gaze sensing application 302 determines that there is a reasonable probability of the gaze leaving the display in question. Reports may be generated automatically by the report generating application 304, or manually by one or more operators. Alternatively, a first part of a report may be generated automatically, and a second part of the report may be generated manually by one or more operators. The report generating application 304 may provide reports to a client or administrator periodically or based on parameters provided by a client or operator. In another example, impression data generated by the sensor/processing system 102 is not stored, but used directly to generate reports.

The report generating application 304 may comprise software controlled by the processor 342 (or by another processor), for example. Alternatively, the report generating application 304 may comprise circuitry, or a combination of software and circuitry.

In this example, the report generating application 304 receives information from the gaze sensing application 302 and records the information in a predetermined format. The report may take many different formats, and may include textual and/or graphical data. Also, in a preferred embodiment, an administrator may specify a number of rules defining how the impressions and other events are to be recorded. For example, if a monitoring client terminal 110 displays report data, an administrator may wish to configure a number of rules that will cause the report generating application 304 to record only certain types of impression data, such as the total number of impressions, while not recording any data about the duration of the impressions or other metrics.

The report generating application 304 continues to record data until a stop signal is received from the gaze sensing application 302. In this example, the gaze sensing application 302 generates a stop signal upon detecting that the viewer's gaze has left the display. The report generating application 304 subsequently generates a report, and provides the generated report to a client or administrator. The report may be displayed to an administrator immediately upon detecting the viewer's gaze leaving the display for which the report was created. Alternatively, an administrator may control when to view the report.

As mentioned above, the report may take many different formats, and may include a series of textual and/or graphical displays, highlighting of certain elements on the application's viewer interface, a fast forward display of what happened while the operator was not actively monitoring the impression data, a combination thereof, or some other format. A client or administrator may define a number of rules to be used by the report generating application 304 to prioritize which of the recorded data should be shown first. In that case, the report generating application 304 may process data from many displays, and may report the highest priority items first.

The report generating application 304 may then save each report in a database, such as in a report database 306. The database 306 may be stored in the memory 344, for example. The database 306 may comprise any data storage entity that provides writing and reading access. The database 306 may record any data for the report generating application 304, and the data may be stored in a storage device, such as a computer's hard disk. The media player client terminal may also receive data from one or more input device(s) including a mouse, a keyboard, touchpad, stylus or a touch-screen display device, or a combination thereof.

The operating system 308 may be used to manage hardware and software resources of the media player client terminal 221. General functions of the operating system 308 may include processor management, memory management, device management, storage management, application interface, and user interface. Any type of operating system may be used to implement the present embodiments, and examples of common operating systems include the Microsoft WINDOWS family of operating systems, the UNIX family of operating systems, or the MACINTOSH operating systems. However, the added complexity of an operating system may not be necessary to perform the functions described herein. For example, firmware on a custom microprocessor may also perform these tasks.

In the example of FIGS. 2B and 3A, the report generating application 304 communicates with the display 202 used for advertising. However, the report generating application 304 may also monitor more than one display. Displays may consist of digital displays, print ads, POP (point of purchase), end of aisle displays, out-of-home, or any other visual medium where impressions can be measured. The report generating application 304 may then communicate over a network with the gaze tracking unit 204 and with displays associated with other media player client terminals, and may mediate the reporting process over one or more networks.

The report generating application 304 may perform its functions in response to other user attention based inputs besides or along with gaze tracking. For example, the report generating application 304 may manage the reports when it detects that multiple people are looking at a display and when people are smiling. However, it should be understood that different events could also be considered impression data, such as looking away, smiling, laughing, pointing, crying, frowning, and other emotional indicators.

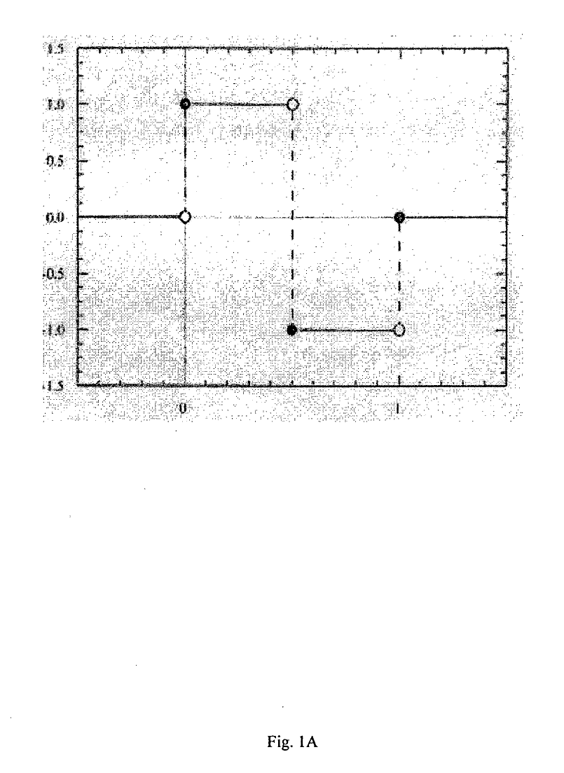

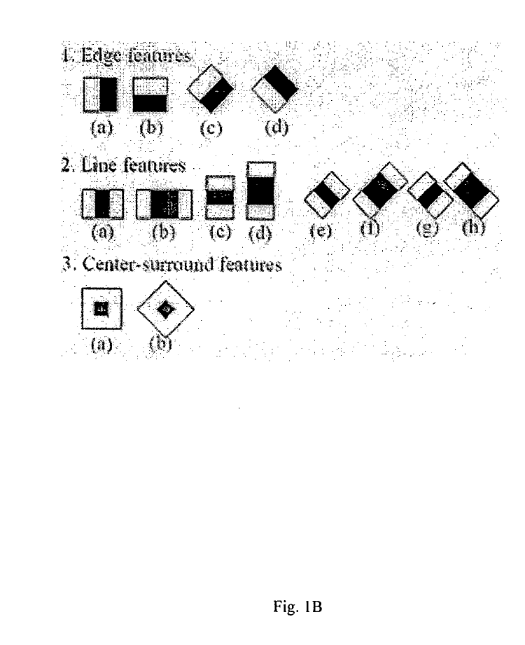

FIG. 3B is a block diagram of an example of the monitoring client terminal 110, used in the embodiment of FIG. 1. The monitoring client terminal 110 comprises a processor 361, a memory 367, an interface 369, an invoice generating application 322, and an operating system 324. The monitoring client terminal 110 may comprise a processing device such as a computer. The processing device may comprise a personal computer or a laptop computer, for example. The monitoring client terminal 110 may also comprise a cellphone or similar processing device.

The invoice generating application 322 may comprise software controller by the processor 361, for example. Alternatively, the invoice generating application 322 may comprise circuitry or a combination of software and circuitry. The invoice generating application 322 may comprise a standalone software application or software running within any other type of software application, such as a web browser, an operating system, etc.

The processor 361 has enough processing power to handle and process various types of gaze information displayed on a webpage or within the standalone application. A typical present day processor has enough processing power to handle and process various types of impression data as represented through the invoice generating application 322. Multiple processors may be used, as well. The memory 367 may include any computer readable medium, such as a disk drive, tape drive, optical disk, etc. The invoice generating application 322 has access to impression information received from the host server 106, through the interface 369, which may comprise any suitable interface such as an API.

When the invoice generating application 322 receives a report from the host server 106, the invoice generating application 322 presents the report to a client, to a system administrator or other operator of the monitoring client terminal 110. The report may be presented in any suitable format, such as on a computer display, in print, as an email, etc.

The invoice generating application 322 also generates one or more invoices based on the reports received from the host server 106. Invoices may also be generated based on impression data received from the sensor/processing system 102. In one example, data received by the invoice generating application 322 is used to generate one or more invoices for the purpose of billing advertisers. An invoice may include a physical or digital request for payment based on the impression data. However, different invoice formats such as cell phones text messages, multimedia messages and other electronic transmissions could also be used. Also, the process of converting the impression data to an invoice may be an automated process or a manual process done by an operator or administrator. Invoices may be sent to selected parties automatically or manually.

The operating system 324 may be used to manage hardware and software resources of the monitoring client terminal 110. General functions of the operating system 324 may include processor management, memory management, device management, storage management, application interface, and user interface. Any type of operating system may be used to implement the present embodiments, and examples of common operating systems include the Microsoft WINDOWS family of operating systems, the UNIX family of operating systems, or the MACINTOSH operating systems. However, the added complexity of an operating system may not be necessary to perform the functions described herein.

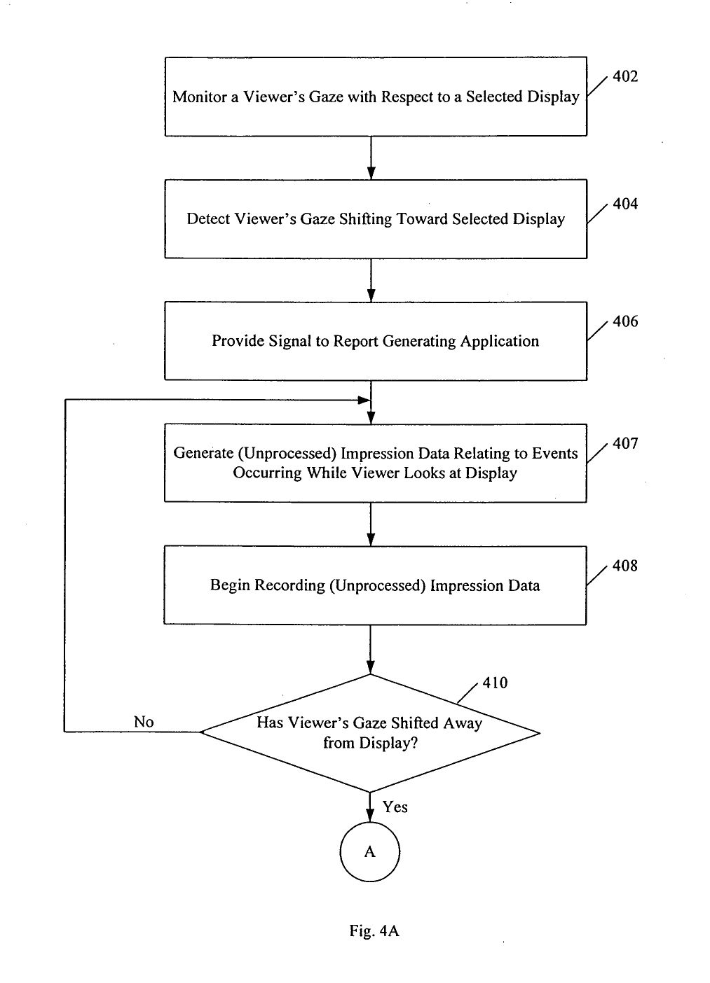

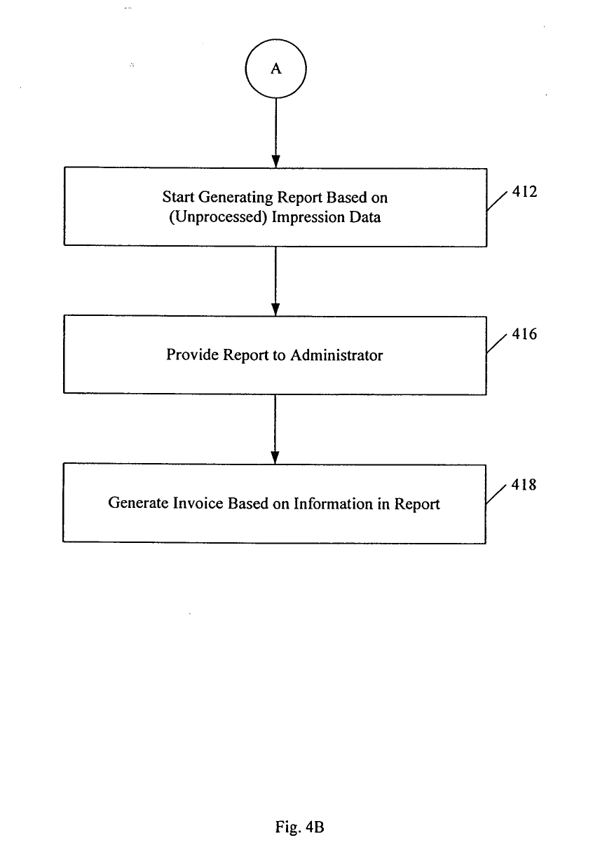

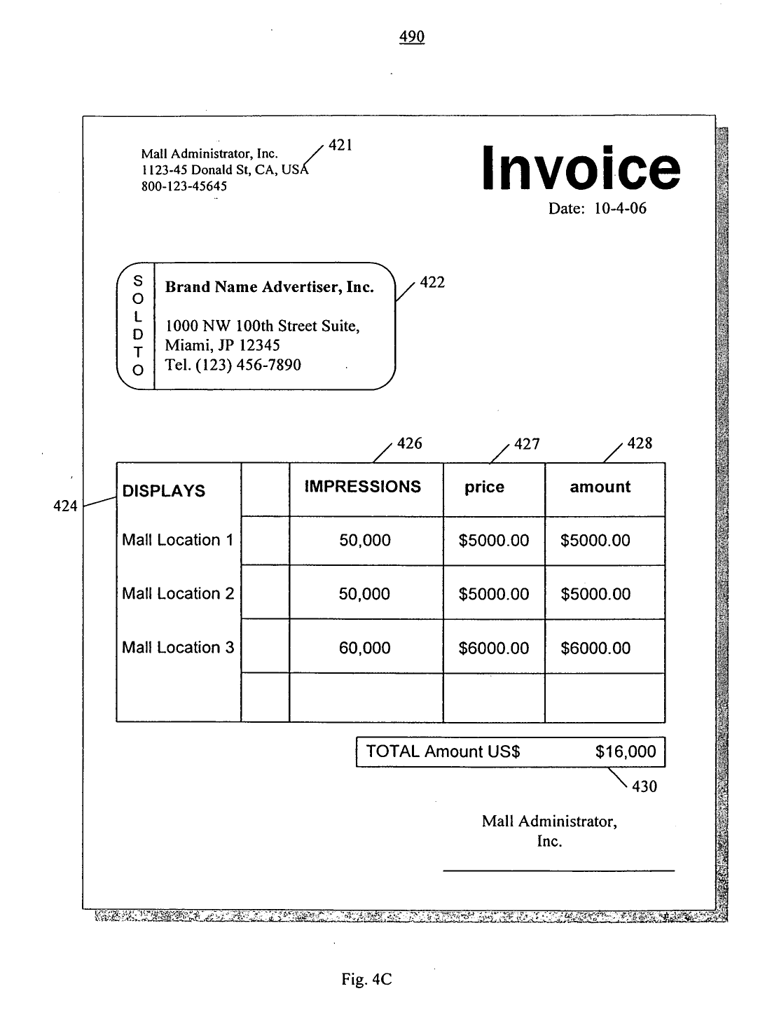

FIGS. 4A and 4B show an example of a method for tracking impressions across one or more displays and billing clients, in accordance with an embodiment of the invention. It should be understood that each block may represent a module, segment, or portions of code, which includes one or more executable instructions for implementing specific logical functions or steps in the process. The method of FIGS. 4A and 4B will be described in relation to the elements of the sensor/processing system of FIG. 2B and the media player client terminal 221 of FIG. 3A. However, more, fewer, or different components could also be used to execute the method of FIGS. 4A-4B. At least certain steps may be executed in a different order from that shown or discussed, including substantially concurrently or in reverse order, depending on the functionality involved.

Referring to FIG. 4A, at step 402, the gaze sensing application 302 monitors a viewer's gaze with respect to a selected display. The gaze sensing application 302 may use inputs that are provided by the gaze tracking unit 204 to determine and display coordinates of the viewer's gaze in relation to at least one display. In a preferred embodiment, the gaze sensing application 302 uses the gaze coordinates to determine the exact angle of the viewer's gaze in relation to one of the displays. At step 404, the gaze sensing application 302 detects the viewer's eyes shifting toward at least one selected display. The gaze sensing application 302 may be configured to detect a viewer's eyes shifting toward a selected advertisement, or a portion thereof, shown on the display, for example. Alternatively, the gaze sensing application 302 may be configured to detect the viewer's eyes shifting away from one or more displays. Also, events other than the viewer's gaze shifting toward from the screen or a portion thereof may be detected, and could trigger the steps of the method described below.

When the gaze sensing application 302 detects that the viewer's eyes have shifted toward the display or a portion thereof, such as from one or more advertisements on the display, at step 406, the gaze sensing application 302 provides a signal to the report generating application 304. The signal may include an identifier defining a display from among multiple displays. The client or administrator may define which of the displays should be monitored by the gaze sensing application 302 so that the gaze sensing application 302 provides a signal to the report generating application 304 only when it detects the viewer's eyes shifting toward the specified display or displays.

At step 407, the gaze sensing application 302 generates impression data, including various types of events relating to the viewer's gaze, and other information relating to the viewer or the viewer's actions. Examples of such information are discussed above. The gaze sensing application 302 may also generate and transmit to the report generating application 304 signals indicating other related information, such as time of day, etc.

At step 408, the report generating application 304 begins to record the impression data. The report generating application 304 records the impression data while the viewer's eyes are directed toward the display. Impression data may be stored in the database 306, for example. The report generating application 304 may also record the time when the viewer's gaze shifts toward the display or a portion thereof, and when the viewer's gaze shifts away, so that it can later go back to the recording and identify the start, and end, of the relevant data. Different methods may be used to identify where the relevant data has started. For example, the report generating application 304 may begin recording the impression data at the time when the gaze sensing application 302 detects that the viewer's gaze is shifting away from the display or a portion thereof. Such information may subsequently be used to calculate the duration of an impression.

In an alternative example, the report generating application 304 may initiate a process of alerting a client, an operator or an administrator upon detecting that the viewer's gaze has shifted toward the display or to one or more advertisements being displayed on the display. Alternatively, the report generating application 304 may enhance, enlarge, or change colors of all or some advertisements or reports not being viewed by the viewer. Further, the report generating application 304 may reorganize the ads and other content being displayed on the display, or may cover some or all ads not being viewed by a viewer with some other content. Also, the process of alerting an administrator could include providing email alerts, mobile device alerts, and other types of alerts. The message content or the type of the alert used may depend on data not being viewed by a viewer at the display or portions of the display. Also, it should be understood that the process of alerting an administrator may be initiated at the time when the viewer shifts his attention toward the display or the ad, or at some other time, such as upon detecting an alert triggering condition along with the viewer's attention being toward a display or an advertisement. For example, an administrator may be alerted at specific times in a video sequence.

At step 410, the gaze control application 304 determines if the viewer's gaze has turned away from the display or from one or more advertisements being displayed on the display. If the viewer is still looking at the display, the routine returns to step 407 and the gaze sensing application 302 continues to generate impression data. Referring to step 410, when the viewer's gaze leaves the display or ads being displayed on the displays, the routine proceeds to step 412 (of FIG. 4B).

At step 412, the report generating application 304 starts to generate a report based on the impression data. The report generating application 304 may also record the time when the viewer's gaze leaves the display, so that it can later identify the end of the relevant data from the recorded data. Where the report generating application 304 only starts recording data upon detecting a user attention based event, the report generating application 304 may stop recording upon detecting the viewer's gaze leaving the display. Alternatively, the report generating application 304 may discontinue generating alerts for an administrator in relation to ads or the display being currently viewed by the viewer, or may stop modifying the display of the advertisements.

A report may include all or some data recorded during the time interval when the viewer's gaze was toward the display, or toward one or more advertisements on the display. Also, the report may take many different formats. For example, the report may include a series of textual and/or graphical displays of what happened during the viewer's impression duration. Alternatively, the report may include a series of screen/window snapshots, or video data highlighting certain elements on the displays during the viewer's impressions. Also, an administrator may control which of the displayed data should be recorded, or what events should trigger the process of recording data. Any combination of report types could be used, or yet some other report type may also be generated.

At step 416, the report generating application 304 provides the report to an administrator through the host server 106 and/or a monitoring client terminal 110. In this example, the host server 106 further processes the impression data. The host server 106 may, for example, format the impression data and/or reports into a format specified by an administrator/operator or a format required by the monitoring client terminal 110. The host server 106 may comprise a software application, such as Apache Tomcat, running on a computer. Apache Tomcat is an open-source application server developed by the Apache Software Foundation, and is available at www.apache.org, for example.

The reporting mechanism may be tailored to user requirements in specific systems and implementations to retrieve whatever data is relevant for their analysis. In one example, this may include reporting any or all of the impression data discussed above, including the number of unique “looks” or impressions, the duration of these impressions, their start and stop times for coordination with content exhibition, demographic data, and/or any other data or metadata retrieved through processing the relevant data structures or the addition of structures to capture available information that might also be useful. This data may be recorded in a report generated in a format selected based on user requests. In one example, a report may be generated in HTML, and a report may be made accessible through any number of mechanisms, on-line or off-line, such as permanent or dial-up internet or modem connection, writing files to removable media such as CD-ROM, or displaying on-screen at any time a user requests or examining them remotely using a standard web-browser or mobile device.

Other information and analyses may be included in a report, as well. Analyses may be automatically generated, or generated manually by human operators. For example, various analyses and graphs may be provided in a report showing how advertisers and/or venue owners may act upon the data to improve sales, product awareness, etc. A report may also include information showing which advertisements among a group of advertisements are most successful. A report may indicate the age, ethnicity and/or gender distributions of the viewers over a selected time period and changes in the distribution over time. Information showing correlations between impression data to purchase data, to customer loyalty data, or to any other desired data set, may also be included in a report. Any of such information may be expressed within a report in the form of textual description or in the form of multi-dimensional graphs, charts and other illustrations. A report may additionally indicate or suggest strategies to capitalize on the impression data—for example, if the impression data indicates a large number of viewers of a very young age are proximate to the advertising location, the display should display or play an advertisement for a toy.

In one example, the report generating application 304 may provide to the administrator a fast forward style of display of what happened during the impression times so that the administrator could control how quickly he reviews the data in the report. However, it is possible that the viewer's eyes may quickly shift to another display while the administrator is viewing the report, only to shift back again to the original or yet another display. In such an event, the report generating application 304 may note that there has not been sufficient time to report to the user all actions that occurred during the time interval when the viewer's gaze was away from the display or one or more windows on the display, and may keep that information stored for later reporting. Optionally, the report generating application 304 may require an acknowledgement of the reported information, such as by an action the viewer may take with an input device, or by detecting that the administrator had a sufficient time to view the reported items.

Alternatively, rather than waiting for the viewer's gaze to turn toward the display, the administrator may opt to view the generated report via another device while the viewer is away from the location of the displays. For example, the administrator may wish to view the report via a wireless device that is capable of receiving and displaying to the user snapshots of information being received from the report generating application 304.

At step 418, the information in the report provided to the administrator is used to create an appropriate invoice. In this example, the invoice is generated automatically by the invoice generating application 322. For example, using the data concerning viewer attention to displays, demographic data, analyses, etc., an invoice may be automatically created and sent to a client associated with the relevant display, such as the advertiser. The price indicated in the invoice may be calculated based on the information provided in the report, using any desired formula, such as a formula agreed upon with a client. Certain types of information in the report may be more costly than other types of information. The client is then charged an amount based on the invoice. Administrators may use the system and methods described above to invoice advertisers based on the number of impressions recorded in the report, demographic data provided, other analyses provided, etc. Alternatively, or in addition, impression data may be used by a system administrator separately from the system software processes, and without generating a report as described above, to generate an invoice manually for the client based on the impression data. In another example, an invoice may be generated partly automatically and partly manually.

As discussed above, report data may be used by the administrator to bill the advertiser based on the number of impressions, the average length of each impression, or any other metrics gathered. The metrics data can be converted to an invoice automatically or manually by the system administrator. Pricing may vary depending on the types of information gathered and provided to the advertiser. For example, a first price may apply to information concerning gaze tracking information, while a second, higher price may apply to demographic data, crowd flow analysis information, etc., which are discussed above.

In another example, a report generating application running on a computer of an advertising campaign administrator may be configured to receive information from report generating applications of the individual displays, and may alert the administrator when one or more preconfigured alert conditions are detected based on the received data from the display. The administrator may view summary reports describing each viewer's activities, snapshots of displays corresponding the viewer's displays, or even full videos of actual viewers during a specific timeframe, along with information defining where the viewer's eyes were fixed during that time. In one example, an administrator is alerted when data flow in the system reaches a predetermined threshold or the system fails.

FIG. 4C is an example of an invoice 490 that may be generated based on impression data, in accordance with an embodiment of the present invention. The invoice of FIG. 4C includes, for each administrator 421 and buyer 422, a list of displays 424 with a corresponding number of impressions 426 and the monetary amount 428 being charged for the number of impressions 426. A price 427, which may differ from the amount being charged, due to a discount, for example, may also be included. In one example, the administrator 421 may be a mall owner and the buyer 422 may be a brand-name advertiser. In another example, the administrator 421 may be a retail store and the buyer 422 may be a market ratings firm like Nielsen. Any two parties may be the buyer and seller. Displays 424 may comprise any display from digital screens to print posters. Also, the column for “impressions” may be replaced or complemented by any type of data or metrics stored in the report 416 provided to the administrator. In another example, impressions may be replaced by average length of an impression, with a corresponding amount 428 invoiced. In another example, both the number of impressions and the average length of those impressions may be used to decide how much to charge. An example might be to charge $1 for every impression plus $5000 for every location with an average impression time of over 5 seconds. However, any data in the administrator report 416 can be used to determine what amount will be invoiced.

In another example, the report generating application 304 may operate in conjunction with another display data application. The report generating application 304 may then notify the display data application of the event that will trigger recording, such as upon detecting a viewer's gaze shifting toward a display or a portion thereof, as in the example described in reference to FIGS. 4A and 4B, or upon detecting some other event, such as a viewer interaction through gesture or cell phone. Later, the report generating application 304 may notify the display data application of another event indicating that the display data application should preferably stop recording. Then, the report generating application 304 may provide another signal upon detecting the occurrence of an event that a report should be prepared and provided to an administrator. These are merely examples, and other scenarios are possible as well.

In another example, the report generating application 304 managing a display that is not being attended by an administrator may encounter an event of such a high priority that it may notify the administrator right away. Because the report generating application 304 continuously receives viewer's gaze position data from the gaze sensing application 302, it may at any time determine the current position of the viewer's gaze based on the received data. Knowing the current viewer's gaze position, the report generating application 304 may send notifications of appropriate severity to administrators. Also, the process of alerting an administrator may include providing email alerts, mobile device alerts, and other types of alerts. The message content or the type of the alert used may depend on the appropriate severity.

In addition to monitoring the viewer's gaze, the gaze sensing application 302 may also use other events as triggers to start managing displayed data. For example, events may include an action of minimizing one or more advertisements on an electronic display. Restoration of the advertisement on the screen may then be considered an event, as well. Upon detecting either of the events above (minimization or restoration), the report generating application 304 may provide a report to the administrator, including significant events that occurred since the last time the viewer saw the ad, or otherwise summarize the activity that has taken place when the ad was minimized or replaced by another advertisement.

The operation of the sensor/processing system 102, the operation of the host server 106, and the operation of the monitoring client terminal 110 may be controlled or implemented by a single party or by different parties. For example, a first party may control the operation of the sensor/processing system 102. This first party may obtain the impression data 112 and provide the impression data 112 to one or more other, different parties. One or more second parties may receive the impression data 112 and further process and/or use the impression data to generate reports and/or generate invoices, and charge advertisers (or other parties) based on the invoices, as described herein. For example, Party A may control the operation of the monitoring client terminal 110, while Party B controls the operation of the monitoring client terminal 110. In such case, the operation of the host server 106 may be controlled by Party A, by Party B, or by another party (Party C).

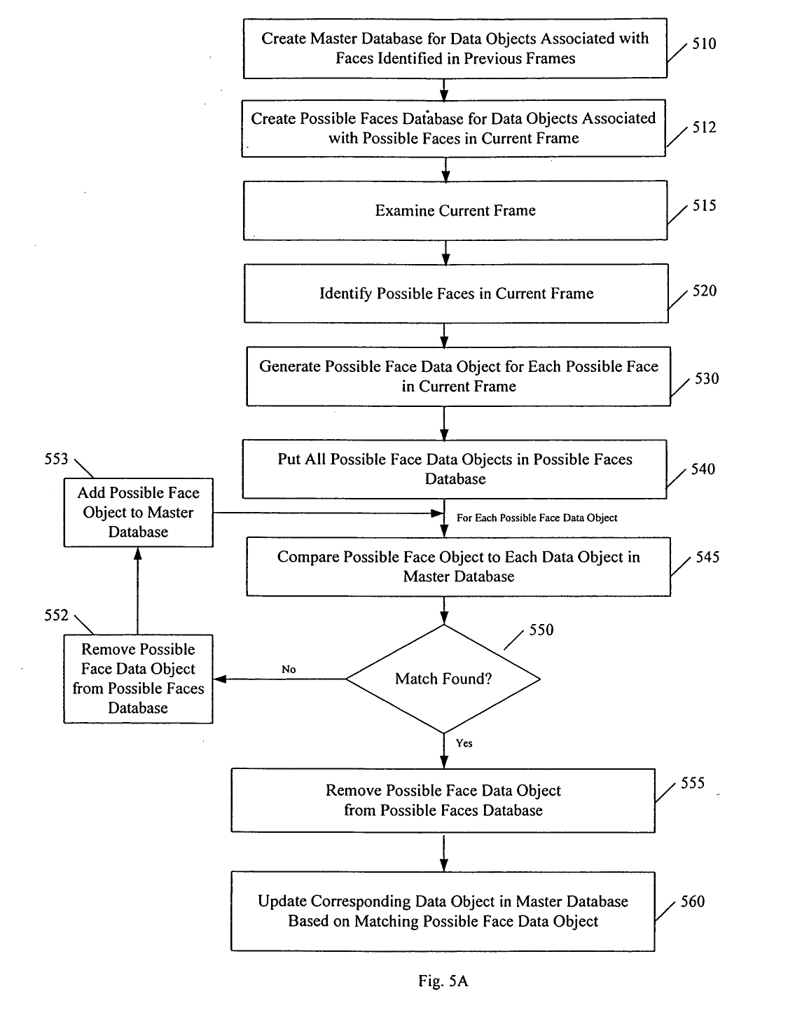

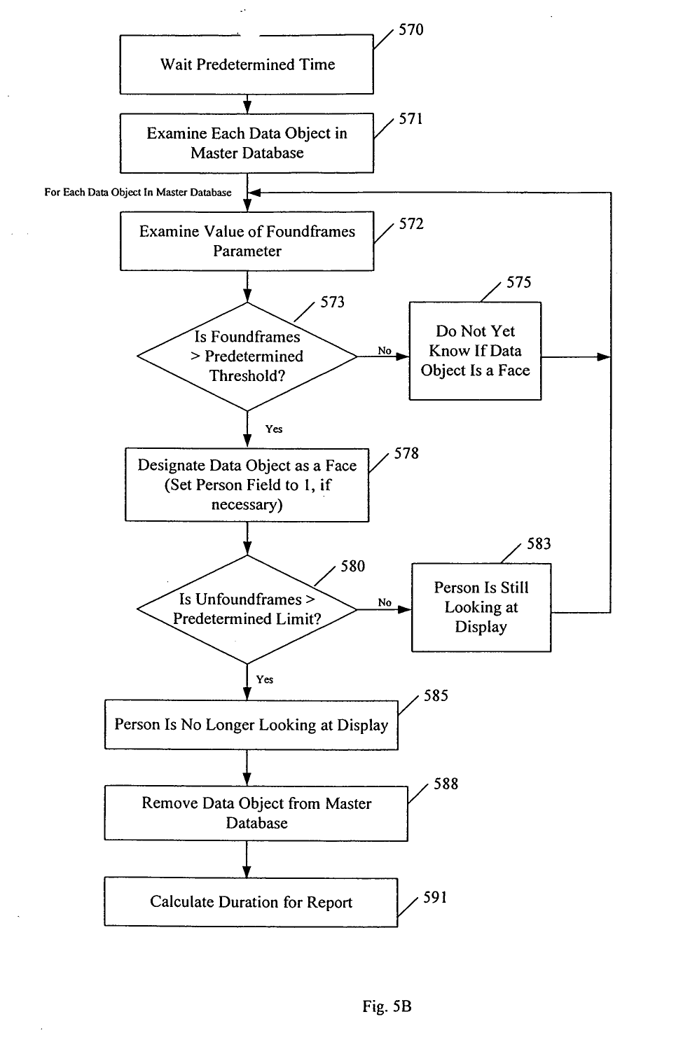

FIGS. 5A and 5B are flowcharts of an example of a method for identifying and monitoring impressions in video images, in accordance with an embodiment of the invention. Prior to real-time implementation of the gaze sensing application 302, it is necessary to train the classifier associated with the gaze sensing application 302 for feature detection, using XML files and programming functions provided in the OpenCV software library, for example. This procedure for supervised learning is well-known in the art.

Any suitable classifier, such as the classifier available from the open-source Computer Vision Library (“OpenCV”), which is discussed above, may be employed. This particular classifier may be found at /www.intel.com/technology/computing/opencv/index.htm.

The implemented classification scheme in the OpenCV software library is essentially a cascade of boosted classifiers working with haar-like features, as is known in the art and described in Paul Viola and Michael J. Jones, “Rapid Object Detection using a Boosted Cascade of Simple Features. IEEE CVPR, 2001,” which is incorporated by reference herein. An improved technique based on the Viola and Jones technique is described in Rainer Lienhart and Jochen Maydt, “An Extended Set of Haar-like Features for Rapid Object Detection,” IEEE ICIP 2002, Vol. 1, pp. 900-903, September 2002, which is also incorporated by reference herein. This improved technique combines a number of classifiers that are “boosted” according to some known learning procedure and arranged in a tree structure. In one example, the AdaBoost learning procedure, available from the OpenCV Library, may be used. This procedure is described in Yoav Freund and Robert E. Schapire, “A decision-theoretic generalization of on-line learning and an application to boosting,” In Computational Learning Theory: Eurocolt '95, pages 23-37. Springer-Verlag, 1995, which is also incorporated by reference herein. AdaBoost works by starting with a classifier that is “weak” or only slightly better than random at classifying the training set. During repeated training, the weights for the samples which the classifier has classified improperly are increased, so that in subsequent trials the classifier is forced to favor these samples over the “easy” cases which it initially classified properly. In this way the weak classifier is “boosted” in favor of detecting harder examples.

When the gaze sensing application 302 is implemented to analyze video data, the application 302 at steps 510 and 512 creates a master database and a possible faces database comprising data objects associated with faces identified in video images. The data structure of the databases 393, 394 is created and then the databases are populated and updated by the process described in steps 515-560. Referring to FIG. 3A, the master database 393 and the possible faces database 394 may be stored in the memory 344, for example. The master database 393 and the possible faces database 394 comprise data structures in a queue data structure based on the structures described in the Standard Template Library (STL) for C/C++ programming, available by Hewlett Packard of Palo Alto, Calif., at www.sgi.com/techlstl/index.html, for example.

In one example, a data object associated with a face in a video image comprises fields or components corresponding to one or more of the following features, without limitation: (1) the center of the face in image coordinates; (2) a unique sequential identifier of the face; (3) an indicator of the time (or video frame) in which the face first appeared; (4) a number of (video) frames in which the face has been found (referred to as the “Foundframes” parameter); (5) a number of frames in which the face is not found since the face first appeared (referred to as the “Unfoundframes” parameter, for example); (6) coordinates defining a rectangle containing the face; (7) a flag indicating whether or not the face has appeared in a previous frame; and/or (8) a flag indicating whether or not the face is considered a person, or an “impression” (referred to as the “Person” parameter, for example).

Steps 515-560 enable the gaze sensing application 302 to monitor faces in consecutive frames and determine how long each person associated with a respective face spends looking at the display 202. At step 515, the gaze sensing application 302 examines a current video frame to identify faces of people who are looking at the display 202. At step 520, the gaze sensing application 302 identifies one or more possible faces in the current frame whose gazes are directed toward the display. At step 530, the gaze sensing application generates a possible face data object for each possible face identified in the current frame. All new possible face data objects are stored in the possible faces database 394, at step 540.

At step 545, the gaze sensing application 302 compares each possible face data object in the possible faces database 394 to each data object in the master database 393 to identify a matching data object, indicating that the face associated with pertinent possible face data object matches the face associated with the selected data object in the master database. Initially, the master database 393 may be empty.

A match is identified by evaluating a distance between the center of one face in the possible faces database 394 and the center of another face in the master database 393. In this example, a match is determined by calculating the Euclidean Distance between the centers of the two faces and comparing the result to some predetermined threshold value (T). If the result is less than or equal to the value the face is considered to be the same face. The threshold value is system/implementation dependent and is directly related to the quality of the video image and size of the area under observation. In one example, the following formula may be employed for this comparison:

\sqrt{(x₁−x₀)²+(y₁−y₀)²}≦T

In the formula above, x and y are image coordinates of the center of the respective faces being compared. In other example, other methods may be used to determine a match.

Referring to step 550, if no match is found, the routine proceeds to step 552 and the possible face data object in question in removed from the possible faces database 394. At step 553, the possible face data object in question is added to the master database 393. Initially there are no data objects in the master database and the routine also proceeds to step 552.

If a match is found at step 550, the possible face data object in question in removed from the possible faces database 394, at step 555. The corresponding, or matching, data object in the master database 393 is updated based on the information in the pertinent possible face data object, at step 560. Thus, for example, any or all of the fields (1)-(8) listed above, in the data object within the master database 393, may be updated based on information in the possible faces data object. In addition to the parameters relating to the features of the observed face, the Foundframes parameter is updated, as necessary. The value of Foundframes may be incremented by 1.0, for example. In one example, when a match is found, the Unfoundframes parameter in the data object in the master database is adjusted by a predetermined amount (such as 0.2), as well.

Each data object in the master database that is not matched to a possible faces data object is updated as well. In particular, the Unfoundframes parameter is adjusted by a predetermined number, such as 1.0.

Periodically, the master database 393 may be updated to reflect that a particular face is no longer looking at the display, for example. FIG. 5B is a flowchart of an example of a method to identify people who are no longer looking at the display, and remove the corresponding data objects from the master database. The routine of FIG. 5B may be performed periodically, for example, once every X frames. X may be five, for example. The gaze sensing application 302 monitors the time, or the number of frames that have been examined, and determines when it is appropriate to update the master database 393. Thus, at step 570, the gaze sensing application 302 waits a predetermined time or number of frames. When it is time to update the master database 393, the gaze sensing application 302 examines each data object in the master database 393 (step 571). For each data object in the master database 393, the gaze sensing application 302 examines the “Foundframes” parameter (step 572). As discussed above, the Foundframes parameter is one of the data items stored in a data object, and indicates a number of frames in which the face has been found. Referring to block 573, if Foundframes is less than a predetermined threshold, a determination is made at step 575 that there is not yet sufficient information to conclude that the pertinent data object is a face. Another data object is selected from the master database 393, and the routine returns to step 572. The predetermined threshold may exceed the value of X, which defines how frequently the master database is updated, as discussed above. In one example, the predetermined threshold exceed the value of X by at least a factor of 2.

Returning to block 573, if the Foundframes parameter equals or exceeds the predetermined threshold, at step 578 the pertinent data object is designated as an “impression,” and the “Person” parameter is updated, if necessary.

Proceeding to block 580, if Unfoundframes is less than a predetermined limit, a determination is made, at block 583, that the person is still looking at the display. As discussed above, the Unfoundframes parameter is one of the data items stored in a data object, and indicates a number of frames in which the face has not been found since the face first appeared. Another data object is selected from the master database 393, and the routine returns to step 572.

If Unfoundframes equals or exceeds the predetermined limit, the routine proceeds to block 585, where a determination is made that the person is no longer looking at the display. In one example, at step 588, the data object is removed from the master database 393. In another example, the data object is not removed but preserved for subsequent comparisons. For example, the data object may be used to identify and track repeat viewers, as described above. At step 591, a duration is calculated for the data object indicating how long the person looked at the display. A report can subsequently be generated based on the information in the data object. The report may note the duration information.

The method described above with reference to FIGS. 5A-5B may be used in other applications as well. The method may be used to identify and monitor faces in video surveillance applications, for example. The method may be implemented in video surveillance of subways, airports, city streets, private buildings, etc. The method may be used in conjunction with other applications such as face recognition applications and/or voice recognition applications.

Examples of implementations of the invention are described above. The invention is not limited to those examples, as it is broad enough to include other arrangements defined by the claims.

For example, the system of FIG. 1, the terminal 221 of FIG. 3A, and the terminal 110 of FIG. 3B, and certain of their respective components are disclosed herein in a form in which various functions are performed by discrete functional blocks. However, in each respective example, any one or more of these functions could equally well be embodied in an arrangement in which the functions of any one or more of those blocks or indeed, all of the functions thereof, are realized, for example, by one or more appropriately programmed processors.

1. A method to charge a party for a display, comprising:
detecting data relating to at least one impression of at least one person with respect to a display; and
charging a party associated with the display an amount based at least in part on the data.

2. The method of claim 1, wherein the at least one impression includes at least one action of the at least one person with respect to the display.

3. The method of claim 2, wherein the action comprises a gaze, the method comprising:
detecting a gaze, of the at least one person, directed toward the display.

4. The method of claim 3, further comprising:
detecting the gaze of the at least one person, by a sensor.

5. The method of claim 4, wherein the sensor comprises at least one video camera, the method further comprising:
examining at least one video image; and
identifying the impression based at least in part on information in the video frame.

6. The method of claim 1, wherein detecting the data comprises:
generating an image; and
deriving information from the image.

7. The method of claim 1, wherein the display comprises at least one advertisement.

8. The method of claim 1, further comprising:
deriving second data based at least in part on the data;
wherein the second data comprises one or more items of information relating to the at least one person, chosen from the group consisting of: a number of impressions that occur during a selected time period, a duration of at least one impression, an average duration of impressions occurring during a selected time period, a number of concurrent impressions, a total number of gazes toward the display, an amount of time associated with one or more gazes, a number of concurrent gazes by the at least one person, a part of the display viewed by the at least one person, age information, race information, ethnicity information, gender information, average age information, one or more facial expressions of the at least one person, one or more emotions of the at least one person, information relating to a voice of the at least one person, one or more gestures of the at least one person, whether the at least one person has appeared multiple times before the display, mobile device use, whether and how often the at least one person has made any phone calls, whether and how often the at least one person has used Bluetooth, whether and how often the at least one person has used text messaging, information obtained from a cell phone, information obtained from a Radio Frequency Identification Technology device, crowd flow analysis information, one or more colors worn by the at least one person, and time data.

9. The method of claim 1, further comprising:
generating an invoice based at least in part on the data; and
sending the invoice to a selected party.

10. The method of claim 1, comprising:
detecting data relating to at least one impression of a plurality of persons during a predetermined time period.

11. A system to charge a party for a display, comprising:
at least one device configured to:
detect data relating to at least one impression of at least one person with respect to a display; and
at least one processor configured to:
charge a party associated with the display an amount based at least in part on the data.

12. The system of claim 11, wherein the at least one impression includes at least one action of the at least one person with respect to the display.

13. The system of claim 11, wherein the at least one device is further configured to:
detect a gaze, of the at least one person, directed toward the display.

14. The system of claim 13, wherein the at least one device comprises:
at least one video camera configured to:
generate at least one video image; and
at least one second processor configured to:
examine the at least one video image; and
identify the impression based at least in part on information in the video frame.

15. The system of claim 11, wherein the display comprises at least one advertisement.

16. The system of claim 11, wherein the at least one processor is further configured to:
generate an invoice based at least in part on the data; and
send the invoice to a selected party.

17. The system of claim 11, wherein the at least one processor is configured to:
detect data relating to at least one impression of a plurality of persons during a predetermined time period.

18. A method to charge a party for a display, comprising:
obtaining data relating to at least one impression of at least one person with respect to a display; and
charging a party associated with the display an amount based at least in part on the data.

19. The method of claim 18, wherein the display comprises at least one advertisement.

20. The method of claim 18, comprising:
receiving the data relating to at least one impression of at least one person with respect to a display.

21. The method of claim 20, comprising:
receiving the data relating to at least one impression of at least one person with respect to a display, by a first party from a second party different from the first party.

22. A method to acquire information concerning actions by individuals with respect to a display, comprising:
examining an image comprising a representation of at least one first person proximate to a display;
identifying a first face of the first person;
comparing the first face to one or more second faces of one or more respective second persons, the second faces being represented by data stored in at least one memory;
if the first face matches a second face:
updating second data representing the matching second face based at least in part on the first face;
if the first face does not match any second face stored in the at least one memory:
storing third data representing the first face in the at least one memory;
generating a report based at least in part on information relating to the first and second faces stored in the at least one memory; and
providing the report to a selected party.

23. The method of claim 22, further comprising:
generating the image comprising the representation of the at least one first person, by a sensor.

24. The method of claim 22, further comprising:
storing fourth data representing the first face in a selected database in the least one memory; and
removing the fourth data from the selected database, if the first face matches a second face.

25. The method of claim 22, wherein the display comprises at least one advertisement.

26. The method of claim 22, wherein the data representing the second faces comprises one or more data items chosen from the group consisting of: a center of a selected second face, a unique identifier of the selected second face, an indicator of a time in which the selected second face first appeared, an indicator of a video frame in which the selected second face first appeared, a number of video frames in which the selected second face has appeared, a number of video frames in which the selected second face has not appeared since the selected face second first appeared, coordinates associated with a rectangle containing the selected second face, an indicator indicating whether or not the selected second face has appeared in a previous video frame, and an indicator indicating whether or not the selected second face is considered a person.

27. The method of claim 22, further comprising:
selecting a second face represented by specified data in the at least one memory;
examining a first value indicating a first number of images in which the selected second face has appeared and a second value indicating a second number of images in which the selected second face has not appeared;
if the first value exceeds a first predetermined threshold and the second value exceeds a second predetermined threshold:
removing the specified data representing the selected second face from the at least one memory.

28. The method of claim 22, comprising:
identifying the first face, by a processor; and
comparing, by the processor, the first face to one or more second faces of one or more respective second persons, the second faces being represented by data stored in the at least one memory.

29. The method of claim 22, further comprising:
deriving fourth data based at least in part on information relating to the first and second faces stored in the at least one memory;
wherein the fourth data comprises one or more items of information relating to the at least one person, chosen from the group consisting of: a number of impressions that occur during a selected time period, a duration of at least one impression, an average duration of impressions occurring during a selected time period, a number of concurrent impressions, a total number of gazes toward the display, an amount of time associated with one or more gazes, a number of concurrent gazes by the at least one person, a part of the display viewed by the at least one person, age information, race information, ethnicity information, gender information, average age information, one or more facial expressions of the at least one person, one or more emotions of the at least one person, information relating to a voice of the at least one person, one or more gestures of the at least one person, whether the at least one person has appeared multiple times before the display, mobile device use, whether and how often the at least one person has made any phone calls, whether and how often the at least one person has used Bluetooth, whether and how often the at least one person has used text messaging, information obtained from a cell phone, information obtained from a Radio Frequency Identification Technology device, crowd flow analysis information, one or more colors worn by the at least one person, and time data.

30. The method of claim 22, wherein the at least one memory comprises one or more databases, the method further comprising:
comparing the first face to one or more second faces of one or more respective second persons, the second faces being represented by data stored in the one or more databases.

31. A system to acquire information concerning actions by individuals with respect to a display, comprising:
at least one memory configured to:
store data;
at least one processor configured to:
examine an image comprising a representation of at least one first person;
identify a first face of the first person;
compare the first face to one or more second faces of one or more respective second persons, the second faces being represented by data stored in the at least one memory;
if the first face matches a second face:
update second data representing the matching second face based at least in part on the first face;
if the first face does not match any second face stored in the at least one memory:
store third data representing the first face in the at least one memory;
generate a report based at least in part on information relating to the first and second faces stored in the at least one memory; and
provide the report to a party in response to a request for desired information relating to first person and second persons.

32. The system of claim 31, further comprising:
at least one sensor configured to:
generate the image comprising the representation of the at least one first person.

33. The system of claim 31, further wherein the at least one processor is further configured to:
store fourth data representing the first face in a selected database stored in the at least one memory; and
remove the fourth data from the selected database, if the first face matches a second face.

34. The system of claim 31, wherein the at least one processor is further configured to:
select a second face represented by specified data in the at least one memory;
examine a first value indicating a first number of images in which the selected second face has appeared and a second value indicating a second number of images in which the selected second face has not appeared;
if the first value exceeds a first predetermined threshold and the second value exceeds a second predetermined threshold:
remove the specified data representing the selected second face from the at least one memory.

35. The system of claim 31, wherein:
the at least one memory is further configured to:
store data in one or more databases;
the at least one processor being configured to:
compare the first face to one or more second faces of one or more respective second persons, the second faces being represented by data stored in the one or more databases.

36. A computer readable medium encoded with computer readable program code, the program code comprising instructions operable to:
examine an image comprising a representation of at least one first person;
identify a first face of the first person;
compare the first face to one or more second faces of one or more respective second persons, the second faces being represented by data stored in the at least one memory;
if the first face matches a second face:
update second data representing the matching second face based at least in part on the first face; and
if the first face does not match any second face stored in the at least one memory:
store third data representing the first face in the at least one memory.

37. The computer readable medium of claim 36, wherein the program code further comprises instructions operable to:
generate a report based at least in part on information relating to the first and second faces stored in the at least one memory; and
provide the report to a party in response to a request for desired information relating to first person and second persons.

38. The computer readable medium of claim 36, wherein the program code comprises instructions operable to:
compare the first face to one or more second faces of one or more respective second persons, the second faces being represented by data stored in one or more databases maintained in, the at least one memory.
